(19) United States
(12) Patent Application Publication
(10) Pub. No.: US 2014/0249782 A1
(43) Pub. Date: Sep. 4, 2014

(54) DYNAMIC POWER PREDICTION WITH PIN ATTRIBUTE DATA MODEL

(71) Applicant: INTERNATIONAL BUSINESS MACHINES CORPORATION, Armonk, NY (US)

(72) Inventors: Aaron J. CUMMINGS, Williston, VT (US); Maurice P. KINNEY, Milton, VT (US); Susan K. LICHTENSTEIGER, Essex Junction, VT (US); Daniel L. STASIAK, Austin, TX (US)

(73) Assignee: INTERNATIONAL BUSINESS MACHINES CORPORATION, Armonk, NY (US)

(21) Appl. No.: 13/782,139

(22) Filed: Mar. 1, 2013

(51) Int. Cl. G06F 17/50

(52) U.S. Cl. CPC G06F 17/50
USPC 703/2

(57) ABSTRACT

Systems and methods are provided for modeling the power consumption of intellectual property (IP) components of a chip by defining how individual pins operate in a particular application. A method is provided for performing a power analysis of an IP design. The method includes generating an activity map that reflects power attributes for each pin that impacts power in the IP design. The method also includes generating specific activity assertions based on the power attributes and chip level usage information for the IP design. The method further includes using a computing device to perform the power analysis using the specific activity assertions.

### FIELD OF THE INVENTION

The invention relates to systems and methods for estimating the power consumption of intellectual property (IP) components of a chip and, more particularly, to systems and methods for modeling the power consumption of IP components of a chip by defining how individual pins operate in a particular application.

### BACKGROUND

Computer power usage is important because the more power a computer uses the higher the cost for a computer owner. A solution is needed to keep the usage of power and related costs down in many electronic devices. For example, power usage may determine battery life for many systems (e.g., laptops) using battery supplies, computers with lower power usage may provide better performance for cloud computing, lower power usage high definition televisions are less expensive to operate and build, and smart phone's with mobile applications that have lower energy usage requirements provide for longer battery life.

Furthermore, when a computer is part of a group of servers or mainframes, power usage may determine the requirements for the building holding the group of servers or mainframes. For example, the power requirements of the group of servers or mainframes may determine the amount of area in the building that is required for holding the group of servers or mainframes, how much power should be brought into the building, and cooling system requirements for the group of servers or mainframes.

Power usage may also determine end of life of a computer and future replacement costs. All of these power usage factors determine cost of ownership and operation for a computer customer.

Today, very large scale integration (VLSI) chips are essentially computing systems on a chip. VLSI chip designs for computers require an understanding of how much power will be used or consumed when the VLSI chip is operating to help determine the overall computer power consumption. At the chip level, power usage may determine power supply needs, battery life, packaging for cooling, reliability, and more. Therefore, it is important to estimate the power usage or consumption accurately and early such that design changes may be made to stay under power requirements for the chip.

There are a number of traditional processes for determining the power usage of a chip. One of the most common processes includes adding up the power contribution of all of the IP components of the chip. Most VLSI chips have complete IP on board. Complete IP may include, but is not limited to, latches, High Speed Serdes (HSS) Cores, Phase Lock Loop circuits (PLLs), Inputs/Output circuits (IOs), and memory elements such as arrays. In addition, there are many different types of each of these complete IP groups. For example, arrays may comprise register files, register arrays, static random access memory (SRAM), dynamic random access memory (DRAM), and ternary content addressable memory (TCAM), with each having different functions and behaviors. There are also different types of HSS cores based on speed differences. There are different types of PLLs, IOs, and latches for various function, timing, and power requirements.

Many of these complete IPs are complex and modeled with inclusive power models. Therefore, many different and complex models should be understood in detail to obtain an accurate power estimate at the higher VLSI chip level. In fact, a power prediction or estimation problem exists even if all the memory arrays (or other complete IP) on a chip are the same type because each memory array instance may be placed in a different mode or accessed differently, such that no one rule can cover all the different instances.

Two common methods for predicting chip power in view of the different complex models for the complete IP is to use simulation data or use one value for switching activity on all nets (i.e., the wires connecting all the logic components together for each IP component). The use of simulation data includes simulating the chip with a test case to understand net switching activity, saving switching activity for all nets, and applying switching activity for each net for power simulation (set array pin switching activity as it occurred in simulation). This method may provide an accurate power prediction. However, this method requires that the chip design be far enough along such that there is a simulation model available. This method also requires that a chip level simulation be available, which is difficult in terms of memory requirements, processing requirements, and simulation time. In other words, the information provided to perform the power consumption analysis may be provided too late in the design process to allow for changes in the chip design.

The use of one value for switching activity on all nets includes assuming one value for all net switching activity on a chip, and applying the switching activity to each net for power simulation (all array pins have the same switching activity). This method may be easy to implement and could be performed early in the chip design. However, this method is not a realistic means to predict power for each individual IP component. Specifically, the power estimate is not very accurate since none of the information detailing how the IP component works is used for the power consumption analysis.

Accordingly, there exists a need in the art to overcome the deficiencies and limitations described hereinabove.

### SUMMARY

In a first aspect of the invention, a method is provided for performing a power analysis of an IP design. The method includes generating an activity map that reflects power attributes for each pin that impacts power in the IP design. The method also includes generating specific activity assertions based on the power attributes and chip level usage information for the IP design. The method further includes using a computing device to perform the power analysis using the specific activity assertions.

In another aspect of the invention, a method is provided for performing a power analysis of an IP component. The method includes identifying each pin that has power implications for the IP component. The method also includes defining at least one parameter for each of the identified pins. The method further includes generating a function for each of the identified pins using the defined at least one parameter. The method further includes receiving chip level usage information for the IP component. The method further includes generating a specific activity assertion for each of the pins using the function generated for each pin respectively and the chip level usage information. The method further includes using a computing device to perform the power analysis using the specific activity assertions.

In another aspect of the invention, computing system is provided for performing a power analysis of an IP design. The system includes a CPU, a computer readable memory and a computer readable storage media. The system also includes first program instructions to generate an activity map that reflects power attributes for each pin that impacts power in the IP design. The system further includes second program instructions to generate specific activity assertions based on the power attributes and chip level usage information for the IP design. The system further includes third program instructions to perform the power analysis based on the specific activity assertions. The first, second and third program instructions are stored on the computer readable storage media for execution by the CPU via the computer readable memory.

In yet another aspect of the invention, a method is provided for capturing and combining chip level usage information and IP information. The method includes identifying each input/output (I/O) pin that has power implications for an IP component. The method also includes defining at least one parameter for each of the identified I/O pins. The method further includes generating a function for each of the identified I/O pins using the defined at least one parameter. The function is configured to generate a specific activity assertion for each of the I/O pins respectively. The method further includes receiving the chip level usage information for the IP component. The method further includes generating the specific activity assertion for each of the I/O pins using a computing device. The specific activity assertion is generated based on the function generated for each of the identified I/O pins and the received chip level usage information.

### BRIEF DESCRIPTION OF THE SEVERAL VIEWS OF THE DRAWINGS

The present invention is described in the detailed description, which follows, in reference to the noted plurality of drawings by way of non-limiting examples of exemplary embodiments of the present invention.

FIGS. 1 and 2 are illustrative diagrams of memory arrays in accordance with aspects of the invention;

FIG. 3 is an illustrative external environment for implementing the invention in accordance with aspects of the invention;

FIG. 4 is an illustrative process flow for implementing the system in accordance with aspects of the invention;

FIG. 5 is an illustrative diagram for generating pin power attributes in accordance with aspects of the invention;

FIG. 6 is an illustrative diagram for combining usage information with pin power attributes in accordance with aspects of the invention;

FIG. 7 is an illustrative process flow for implementing the system in accordance with aspects of the invention;

FIG. 8 shows comparative experimental data in accordance with aspects of the invention;

FIG. 9 is an illustrative chip process flow in accordance with aspects of the invention; and

FIG. 10 is a flow diagram of a design process used in semiconductor design, manufacture, and/or test.

### DETAILED DESCRIPTION

The invention relates to systems and methods for estimating the power consumption of intellectual property (IP) components of a chip and, more particularly, to systems and methods for modeling the power consumption of IP components of a chip by defining how individual pins operate in a particular application. More specifically, implementations of the invention provide systems and methods for creating a data model to communicate activity assertions (i.e., switching activity and duty cycles) of IP component (e.g., a memory array) pins in a parameterized format. In embodiments, the data model may then be combined with end user input data to constrain the IP component for dynamic power prediction.

In some embodiments, the present invention combines chip level usage information (i.e., information known and provided by a chip level designer) and complete IP information (i.e., information known and provided by an IP component designer) to accurately model power consumption for a given chip. For example, a chip level script may interface each memory array and pull the array's pin power attributes from a model of the memory array. These attributes may be simple equations or functions held within the memory rule explaining the activity factor (AF) or switching factor, and duty cycle (DC) for each array pin. The AF or switching factor determines the frequency a net/pin transitions states between 0 and 1. The DC defines the percentage of time the net/pin is held in low or high (0 or 1) state. The chip level script takes these equations or functions along with chip level information of array usage (e.g., read, write, and sleep usage percentages) and determines an accurate AF and DC for each pin of the array.

Advantageously, the performance of the systems and methods combine chip level usage information and complete IP information from pin power attributes to predict chip power more accurately and at an earlier stage in the chip design process. More advantageously, the present solution uses a simple set of values to model a complex power model in a gate level power analysis. The chip designer does not need to understand the details of the array operation, or have a detailed simulation to get valid results, since the complete IP information provided by the IP component designer is embedded in the IP component model, and the complete IP information includes the equations or functions explaining the AF and DC for each pin.

To explain better the power estimation problem and solution for a computing system such as a VLSI chip, from hereafter, the problem and solution is described with reference to memory arrays. However, other complete IP designs have a similar problem and one of ordinary skill in the art should understand how to apply the methods and systems (i.e., the solution) discussed hereafter for memory arrays to the other complete IP designs.

### Array Power Estimation Problem

A memory array is a complicated integrated circuit design configured to hold information over time while a VLSI chip is operating. The memory array is a significant contributor to chip power consumption, and thus an estimate of overall chip power consumption should include an analysis of each memory array on the chip. Array power prediction requires an understanding on the behavior of each array on the chip. For example, power consumption is highly correlated to how fast signals are capable of switching based on clock rate, e.g., the signals in a processor with a clock rate of 3 GHz (three billion cycles/second corresponding to ˜3.3×10⁻¹⁰ seconds or 0.33 nanoseconds per cycle) are capable of performing an equal amount of switching per second.

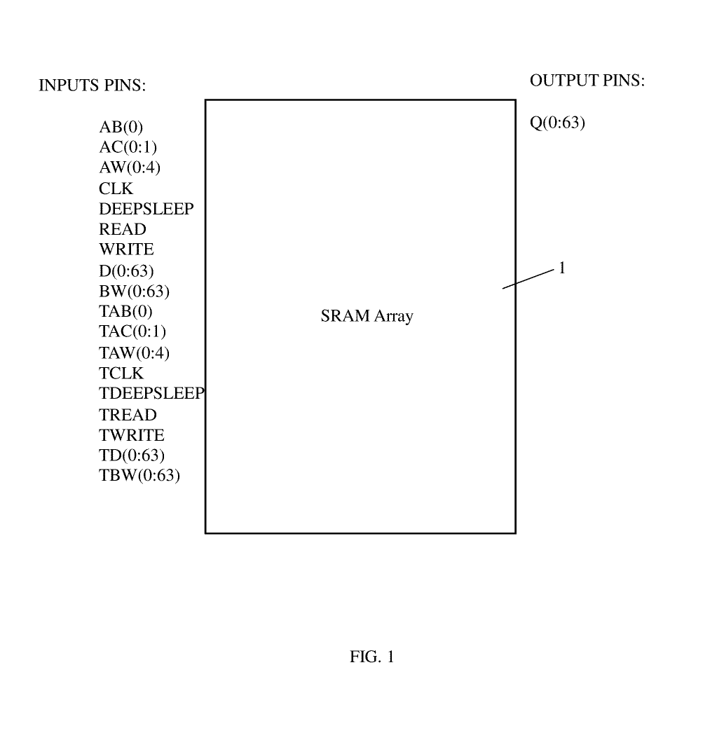

An example of an array is shown in FIG. 1 for an SRAM array 1. This example shows the SRAM array 1 has many input and output pins (I/Os). However, it should be understood that the SRAM array 1 is only an example since other arrays can have different functions and I/Os. There are important relationships between any array's I/Os that should be understood by a chip level designer for valid power prediction. For example, the following are some exemplary relationships for SRAM array 1 I/Os that should be understood to provide an accurate power prediction for the SRAM array 1.

The SRAM array 1 has two operating modes “functional mode” and “test mode.” For SRAM array 1, all inputs starting with the letter “T” may be used when the array is in the test mode operation. Test mode may be used during chip manufacturing or system initiation to detect defect(s) in the SRAM array 1. During chip operation, the SRAM array 1 is typically in functional mode operation. The relationship between these two operating modes is that the inputs starting with “T” are not in operation during the functional mode operation. Consequently, there is a need to define an AF and a DC for those pins that are not in operation during the functional mode operation such that they do not add to the power estimation.

Another example of a relationship between the SRAM array 1 I/Os is between READ, WRITE, and DEEPSLEEP. Each of these three signals may determine which array operation to perform. READ tells the SRAM array 1 to pull information out of memory elements and place the information on output data bus Q (0:63). WRITE tells the SRAM array 1 to pull data from the input data bus D (0:63) and save it in a memory element. DEEPSLEEP tells the SRAM array 1 to stop reading and writing and go into a lower power state. The relationship between these three signals is that only one of these three can be active at a single time. Consequently, the power used by the SRAM array 1 may differ depending on which of the three input pins is active.

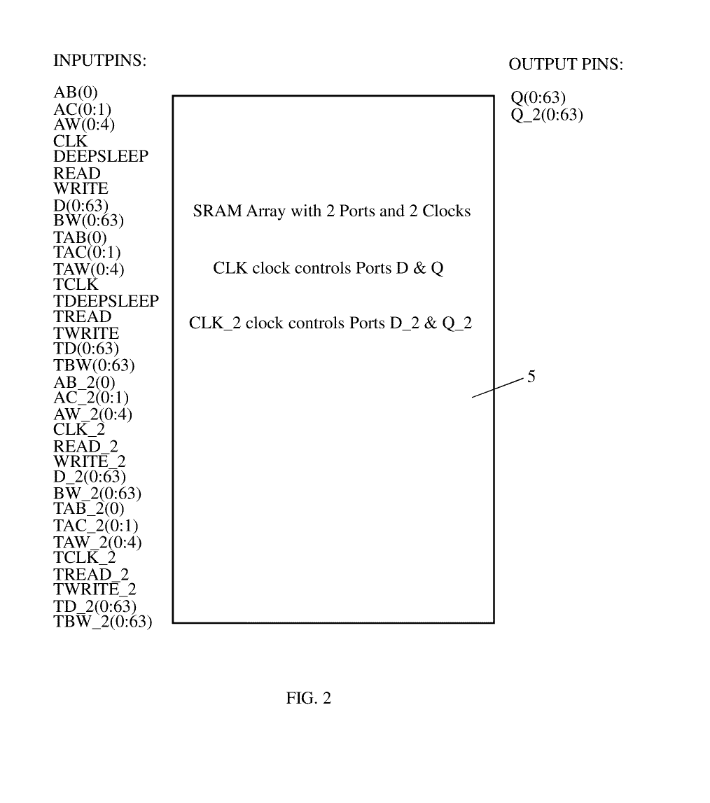

FIG. 2 shows an example of an SRAM array 5 with two ports and two clocks. These I/Os have other important relationships that are different from the previous example in FIG. 1. For example, the clock pin CLK_{—}2 is the clock reference for the I/Os with “_{—}2” in the I/O name. The clock pin CLK is the clock reference to all other I/Os without the “_{—}2”. The two clocks, CLK and CLK_{—}2, may run at the same or different frequencies. However, there is no relationship between I/Os with “_{—}2” in their name and without “_{—}2” in their name except they share the DEEPSLEEP signal.

Therefore, the complexity of the relationships described above with respect to the SRAM arrays 1 and 5 illustrate how each memory array may have different access or usage percentages (e.g., read, write, and sleep usage percentages), which makes power estimation difficult. An accurate power prediction for the memory array 1 and/or 5 should require knowing the switching activity on each array I/O pin, e.g., does the pin switch 1% or 10% of the time. Further, the power prediction for the memory array 1 and/or 5 should require knowing the duty cycle on each array I/O pin, e.g., how often each pin gets held high or low. Additionally, the power prediction for the memory array 1 and/or 5 should require a power model that is specific to the memory array 1 and/or 5, which contains detailed power models of the SRAM from the array designer, including power values that are highly dependent on pin switching and duty cycle information.

A VLSI chip level designer must accurately predict the operation of each pin on the array to produce an accurate chip power value. This value estimate requires some detailed understanding of the IP component (e.g., the memory array) without using global assumptions for all chip components. However, the VLSI chip level designer typically does not know the details of how all the complete IP components of the chip operate (e.g., internal operation of a memory array and internal signals) when estimating the chip power value. Instead, the IP developer or designer of the memory array knows this information.

Specifically, a VLSI chip level designer may know the number of complete IP components required for a chip, the modes that are used for each complete IP component, the frequency by which these modes occur, the above-described relationships between pins on each complete IP component, and the access or usage percentages. However, the VLSI chip level designer does not have the details on the internal workings for each IP component (e.g., a power model that is specific to the memory array 1 and/or 5) to generate a chip power value. Instead, the IP developer or designer of the memory array has the detailed power models.

Accordingly, one goal of the present invention is to take high-level information that the VLSI chip level designer knows and merge that high-level information with the low-level memory array information that the IP developer knows in order to translate high-level information into low-level power assertions that provide for an accurate power estimate for the memory array. In one embodiment, a method and system is provided for that combines the chip level usage information that the VLSI chip level designer is aware of and the complete IP information from pin power attributes that the IP component level developer is aware of to predict chip power more accurately and at an earlier stage in the chip design process.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM),an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

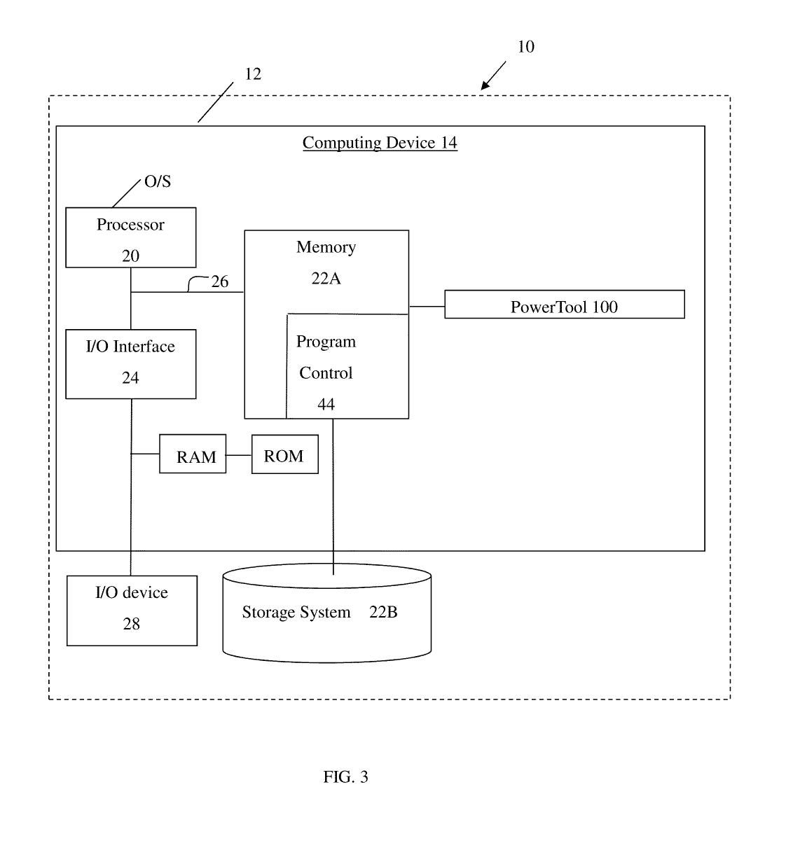

FIG. 3 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 3).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 controls a power tool 100, e.g., at least a portion of an electronic design automation (EDA) application, which performs the processes described herein. The power tool 100 can be implemented as one or more program code in the program control 44 stored in memory 22A as separate or combined modules. Additionally, the power tool 100 may be implemented as separate dedicated processors or a single or several processors to provide the function of these tools.

In embodiments, the power tool 100 may be configured to calculate or estimate power consumption for an IP component and/or a chip based on generated and assigned AF and DC information, and optionally other assertions. The power tool 100 may then be further configured to generate a power analysis or report comprising the power consumption calculated or estimated for the IP component and/or a chip. In alternative or additional embodiments, the power tool 100 may be further configured to generate specific activity assertions (e.g., AF and DC information) based on pin power attributes and usage information. The power tool 100 may then be further configured to assign the generated AF and DC information to each corresponding pin of an IP component.

While executing the computer program code, the processor 20 can read and/or write data to/from memory 22A, storage system 22B, and/or I/O interface 24. The program code executes the processes of the invention. The bus 26 provides a communications link between each of the components in the computing device 14.

The computing device 14 can comprise any general purpose computing article of manufacture capable of executing computer program code installed thereon (e.g., a personal computer, server, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

### Array Power Estimation Solution

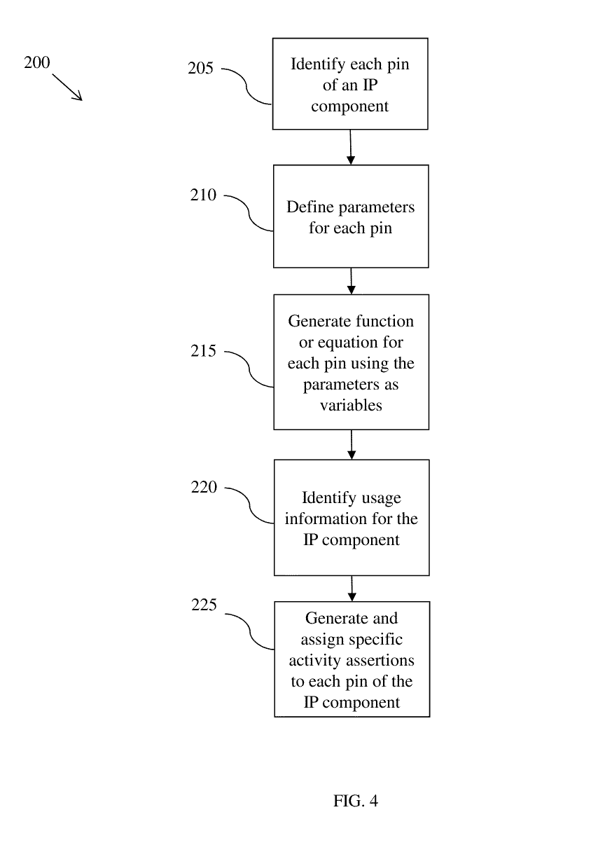

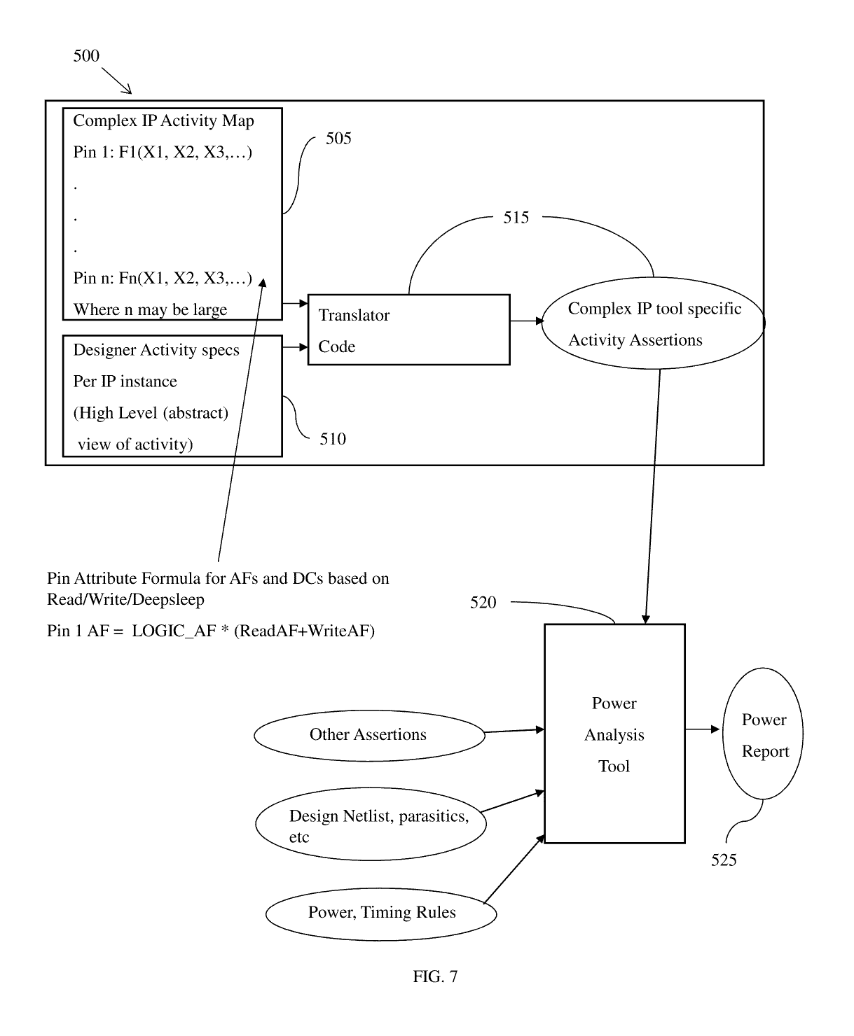

FIGS. 4 and 7 show exemplary flows for performing aspects of the present invention. The steps of FIGS. 4 and 7 may be implemented using power analysis tool of FIG. 3, for example.

The flowcharts and/or block diagrams in FIGS. 4 and 7 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the exemplary power analysis tool of FIG. 3. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disc—read/write (CD-R/W) and DVD.

In embodiments of the present invention, an IP developer may build a high-level activity to low-level or detailed activity map such that knowledge (i.e., the chip level usage information) of the chip level designer may be combined with knowledge (complete IP information from pin power attributes) of the IP component level developer. In accordance with aspects of the present invention, this mapping may comprise identifying each pin of an IP component, defining parameters for each pin, and generating formulas for each pin using the parameters as variables.

When predicting the power for an IP component, in this example array, two pieces of information may be required. As should be understood, this solution is written for an array as an example but any IP component can use this solution. The first piece of information that may be required is from the chip viewpoint (high-level) and may include usage information such as percentages reflecting the frequency (i.e., how often) that the array is accessed with a read, write, search, refresh commands, and/or other IP functions, and the frequency that the array is put to sleep. The variables associated with this first piece of information greatly influence and determine the power of the array. The second piece of information that may be required is from within the inside of the array (low-level) and may include pin power attributes such as how the array works. For example: (1) when is an address bus toggled, during reads only, during writes only, during read and writes; (2) how is the data bus toggled for reads or writes; and (3) what happens when the read/write pin is asserted high or low. The variables associated with this second piece of information greatly influence and determine the power of the array. These two pieces of information may then be used for estimating power usage or consumption of a chip using the arrays.

In embodiments, as shown in FIG. 4, a process 200 for capturing and combining these two pieces of information is provided. For example, prior to laying out the physical design of a chip comprising an IP component, the IP developer builds a high-level activity to low-level or detailed activity map such that the knowledge (e.g., the chip level usage information) of the chip level designer may be combined with the knowledge (complete IP information from pin power attributes) of the IP component level developer.

At step 205, each I/O pin that has power implications for an IP component may be identified. For example, the IP component level developer may identify each I/Opin (e.g., Pin AW(0)) that has power implications for a memory array. At step 210, parameter(s) for each pin may be defined. The parameters identify the variables for power attributes associated with each pin. For example, the IP component level developer may define each parameter (e.g., read activity factor (RAF) and write activity factor (WAF)) for each pin that identifies the variables for power attributes (e.g., PWR_AF and PWR_DC) associated with each pin (e.g., Pin AW(0)).

At step 215, a function or equation may be created for each pin using the parameters as variables. For example, the IP component level developer may define a function or equation for each pin using the parameters as variables. The function or equation may be configured to generate specific activity assertions (e.g., AF and DC information) based on the parameters defined for each pin. For example, the function or equation for the specific activity assertion (AF) for Pin AW(0) may comprise Pin AW(0)_AF=LOGIC_AF*PWR_AF, where PWR_AF is the power attribute for the Pin AW(0) and comprises the parameters RAF+WAF. The function or equation for the specific activity assertion (DC) for Pin AW(0) may comprise Pin AW(0)_DC=PWR_DC, where PWR_DC is the power attribute for the Pin AW(0) and comprises the parameter 0.5. It should be understood that these are only illustrative examples and other functions or equations are also contemplated in accordance with the methods and systems described herein.

At step 220, usage information for the IP component may be identified. For example, the chip level designer may identify usage information comprising for example access or usage percentages (read, write, and sleep usage percentages). The access or usage information may include for example READ_AF=0.5 (50%), WRITE_AF=0.5 (50%), DEEPSLEEP_AF=0 (0%), and LOGIC_AF=0.04 (4%).

At step 225, the specific activity assertions may be generated and assigned to each pin of the IP component based on the functions or equations created in step 215 and the usage information provided in step 220. For example, activity or switching, and duty cycle information may be generated and assigned for each pin of the IP component based on the pin power attributes and the usage information for the IP component. The specific activity assertion (AF) for Pin AW(0) may comprise Pin AW(0)_AF=LOGIC_AF*PWR_AF, where Pin AW(0)_AF=LOGIC_AF*(RAF+WAF); =0.04*(0.5+0.5); =0.04. The specific activity assertion (DC) for Pin AW(0) may comprise Pin AW(0)_DC=PWR_DC, where PWR_DC=0.5.

In some embodiments, the specific activity assertions may be generated and assigned in a format needed for any chosen power analysis tool. In alternative or additional embodiments, the pin power attributes and the usage information for the IP component (e.g., the memory array) may be input directly into a power analysis tool (e.g., the power tool 100 as described with respect to FIG. 3). The power analysis tool may be configured to generate the specific activity assertions (e.g., AF and DC information) based on the pin power attributes and the usage information. The power analysis tool may be further configured to assign the generated AF and DC information to each corresponding pin of the IP component.

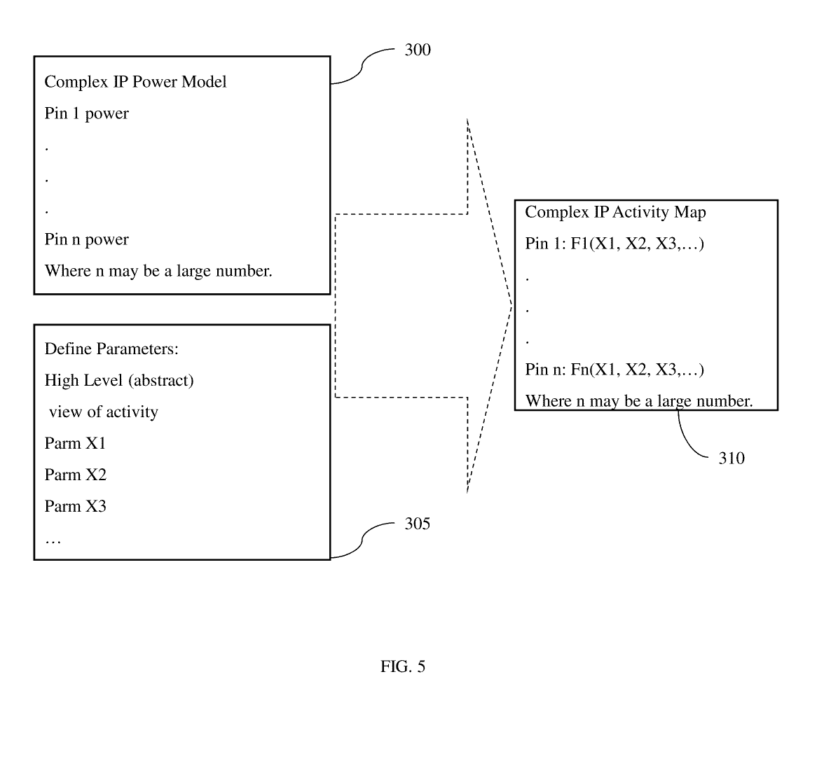

FIG. 5 shows functions or equations generated for each pin of an IP component. For example, in block 300, each pin of the IP component may be defined as Pin 1−Pin “n”, where “n” may be a large number in instances of complex IP components. In block 305, parameter(s) for each pin may be defined as Parm X1−Parm×“n”. The parameters may identify the variables for power consumption by each pin to provide a high-level view of power activity for the IP component. For example, the IP component level developer may define each parameter (e.g., Parm X1, Parm X2 . . . Parm Xn) for each pin that identifies the variables for power attributes associated with each pin (e.g., Pin 1, Pin 2 . . . Pin n). The variables for power consumption may include logic activity factors (LOGIC_AF), writing activity factors (WAF), reading activity factors (RAF), etc.

In block 310, functions or equations may be created such as Pin 1: F1(X1, X2, X3 . . . )−Pin “n”: Fn(X1, X2, X3 . . . ) for each pin using the parameters as variables. For example, the IP component level developer may define a function or equation for each pin using the parameters as variables, where “n” may be a large number in instances of complex IP components. Thus, functions or equations are generated for each pin of the IP component.

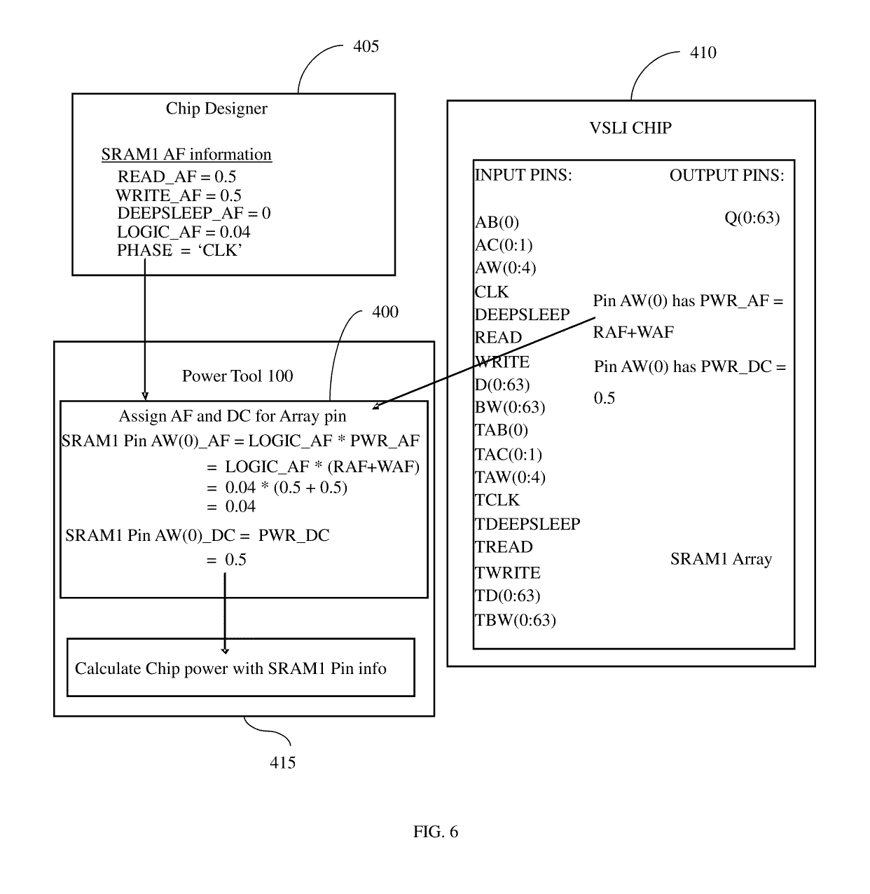

FIG. 6 shows in block 400 the power tool 100 (described with respect to FIG. 3) combining usage information obtained from a chip designer with pin power attributes obtained from an IP component model developed by an IP component level developer. In some embodiments of the present invention, the process for calculating the power usage or consumption of the chip using the IP components may comprise providing a power analysis tool with IP component usage information. Specifically, the chip designer may assign specific values for each parameter (e.g., READ_AF, WRITE_AF, SLEEP_AF, (SEARCH AF . . . CAM only), (refresh AF . . . DRAM only), optionally {LOGIC_AF}, and optionally {PHASE ‘clock_phase_name’}) of each IP component (e.g., a memory array) of the chip, as shown in block 405. For example, the chip designer may provide the power tool 100 (as discussed with respect to FIG. 3) with array usage information. The array usage information for the SRAM array 1 of FIG. 1 may include values such as READ_AF=0.5 (50%), WRITE_AF=0.5 (50%), DEEPSLEEP_AF=0 (0%), LOGIC_AF=0.04 (4%), and PHASE=‘CLK’. However, these are example values and the present invention is not limited to only these values.

Once the array usage information is received by the power tool 100, the power tool 100 may be configured to go to each array instance on the chip and query each array instance for pin power attributes (e.g., AF and DC attributes) on each pin as defined by the array's power model provided by the IP component level developer, as shown in block 400. For example, each array pin may have AF and DC power attributes (e.g., PWR_AF and PWR_DC) assigned within the power model, as shown in block 410. Specifically, the power model may provide pin AW(0)'s attributes (Address Bus bit 0) for example: Pin AW(0) may have PWR_AF=“xxxx” and Pin AW(0) may have PWR_DC=“yyyy” (i.e., PWR_AF=Power Activity Factor and PWR_DC=Power Duty Cycle).

In some embodiments, the power attributes may be provided within the power model one of the following parameters or values: 0, 1, {any floating point number 0.0<value<1.0), read activity factor (RAF), write activity factor (WAF), sleep activity factor (SAF), refresh activity factor (REFAF), RAF+WAF, 1-RAF, 1-WAF, 1-(RAF+WAF), 1-REFAF, bank search activity factor (BSEAF), BSEAF+SAF, RAF+WAF+BSEAF, SAF+BSEAF, WAF+BSEAF+SAF (these are example values and the present invention is not limited to only these attributes). The parameters or values of power attributes may be used to define a formula or equation for determining the power consumption for each pin. For example, the pin on a dedicated “READ” address port may have the power attribute value “RAF” indicating that the pin may switch based on the fraction of the time, on average, that the array is being used in read operations.

In accordance with aspects of the invention, the power tool 100 may calculate and assign a numeric value for the net that is connected to each array pin, as shown in block 400. The net may receive the pin's usage information (e.g., the AF and DC usage percentages) provided from the chip designer and the pin power attributes (e.g., PWR_AF and PWR_DC) provided by the power model (It should be understood that AF and DC are not the only possible usage information and power attributes, and the solution is not limited to only these attributes). For example, if the chip designer provided the power tool with the following usage information for SRAM1 from FIG. 1: READ_AF=0.5, WRITE_AF=0.5, DEEPSLEEP_AF=0, LOGIC_AF=0.04, and PHASE=‘CLK’, and if the power model for SRAM1 in FIG. 1 provided the following power attributes and equations for pin AW(0), Address Bus bit 0: Pin AW(0) has PWR_AF=RAF+WAF and Pin AW(0) has PWR_DC=0.5, then the power tool may be configured to assign the following power attributes to pin AW(0): pinAW(0)_AF=LOGIC_AF*PWR_AF=LOGIC_AF*(RAF+WAF)=0.04*(0.5+0.5)=0.04 and pinAW(0)_DC=PWR_DC=0.5. The activity factor is a percentage, in this case 4%. This means 4% of the time this pin will be switching. However, the actual “switching frequency” on the pin (trans/sec) may be based on the clock frequency that is assigned to the pin in the timing assertions.

In embodiments, the power tool can now use the switching or activity factor (e.g., 4%), and duty cycle (e.g., 50%) percentages calculated for each pin to calculate the IP component and/or chip power consumption, as shown in block 415. For example, the power tool may calculate the power of each memory array based on the chip designer's read, write and sleep activity percentages and the pin power attributes from the power model. In some embodiments, the chip designer may not need to calculate the AF or DC for nets entering or exiting the arrays.

Accordingly, as shown in FIG. 7, a process 500 is provided for estimating power consumption of an IP component and/or a chip. For example, chip level usage information may be combined with complete IP information from pin power attributes to estimate power consumption of the IP component and/or the chip.

At step 505, a high-level activity to low-level or detailed activity map is generated as described in detail above with respect to process 200. In this step, the knowledge (e.g., the chip level usage information) of the chip level designer may be combined with knowledge (complete IP information from pin power attributes) of the IP component level developer to generate the high-level activity to low-level or detailed activity map. For example, each I/O pin that has power implications for the IP component may be identified, parameter(s) for each pin may be defined, and functions or equations may be created for each pin using the parameters as variables. For example, the function or equation for the specific activity assertion (AF) for Pin AW(0) may comprise Pin AW(0)_AF=LOGIC_AF*PWR_AF, where PWR_AF is the power attribute for the Pin AW(0) and comprises the parameters RAF+WAF. The function or equation for the specific activity assertion (DC) for Pin AW(0) may comprise Pin AW(0)_DC=PWR_DC, where PWR_DC is the power attribute for the Pin AW(0) and comprises the parameter 0.5.

At step 510, usage information for the IP component may be identified. For example, the chip level designer may identify usage information, such as, how often the array is accessed with a read, write, search, refresh, and/or other IP functions, and how often the array is put to sleep. The usage information is a high-level view of activity for the IP component and may comprise the chip designer's read, write, search, refresh, other IP functions, and sleep activity percentages for the IP component on the given chip. The access or usage information may include for example READ_AF=0.5 (50%), WRITE_AF=0.5 (50%), DEEPSLEEP_AF=0 (0%), and LOGIC_AF=0.04 (4%).

At step 515, specific activity assertions may be generated and assigned to each pin of the IP component based on the functions or equations created in step 505 and the usage information provided in step 510. For example, activity or switching, and duty cycle information may be generated and assigned for each pin of the IP component based on the pin power attributes and the usage information for the IP component. The specific activity assertion (AF) for Pin AW(0) may comprise Pin AW(0)_AF=LOGIC_AF*PWR_AF, where Pin AW(0)_AF=LOGIC_AF*(RAF+WAF); =0.04*(0.5+0.5); =0.04. The specific activity assertion (DC) for Pin AW(0) may comprise Pin AW(0)_DC=PWR_DC, where PWR_DC=0.5.

In some embodiments, the specific activity assertions may be generated and assigned in a format (e.g., translator code) needed for any chosen power analysis tool. In alternative or additional embodiments, the pin power attributes and the usage information for the IP component (e.g., the memory array) may be input directly into a power analysis tool (e.g., the power tool 100 as described with respect to FIG. 3). The power analysis tool may be configured to generate the specific activity assertions (e.g., AF and DC information) based on the pin power attributes and the usage information. The power analysis tool may be further configured to assign the generated AF and DC information to each corresponding pin of the IP component.

At step 520, power consumption of the IP component and/or chip may be calculated or estimated based on the specific activity assertions generated and assigned in step 515. For example, the power analysis tool (e.g., the power tool 100 as described with respect to FIG. 3) may be configured to use the switching or activity factor (e.g., 4%), and duty cycle (e.g., 50%) percentages calculated for each pin to calculate the IP component and/or chip power consumption. Since there is a direct correlation between the switching frequency of a pin and the amount of power consumed, the switching or activity factor, and the duty cycle calculated for each pin provide an accurate estimate of the power consumed by the IP component and/or the chip.

Optionally, the power analysis tool may be further configured to calculate or estimate the power consumption of the IP component and/or the chip based on the specific activity assertions and other assertions including timing information for the chip, design netlist for the chip, parasitics such as capacitance of the wiring of the chip, power timing models (e.g., power timing information pulled from the IP component model), etc. The power consumption calculated may include an estimate of static power (e.g., DC power) consumption, an estimate of dynamic power (e.g., AC power) consumption, and/or a combination of both types of power as a total or overall power consumption estimate. The dynamic power may be estimated based on switching and duty cycle attributes, and the static power may be estimated based on duty cycle attributes.

At step 525, a power analysis or report may be generated. For example, the power analysis tool (e.g., the power tool 100 as described with respect to FIG. 3) may be configured to generate a power analysis or report comprising the power consumption calculated or estimated in step 520.

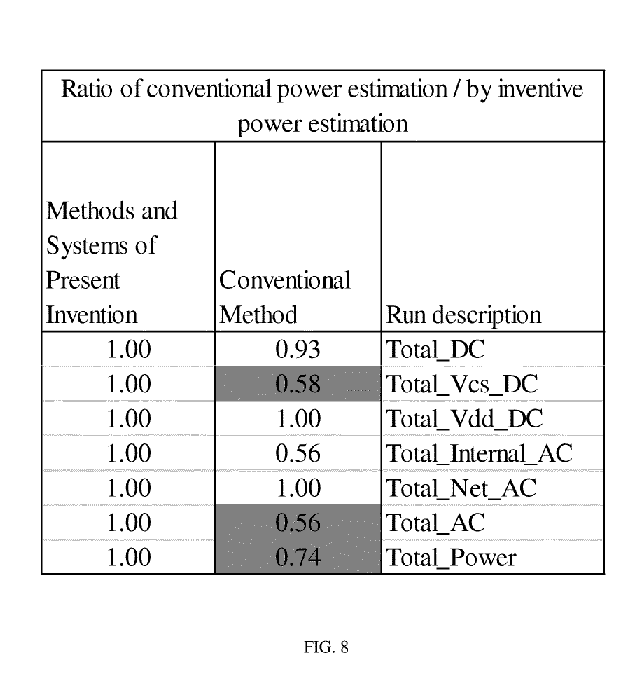

As shown in FIG. 8, the methods and systems of the present invention provide substantially more accurate power estimations when used with IP components, preferably complex IP components. Specifically using conventional methods and systems for power estimation, estimations of Vcs DC power may be off by as much as 42%, estimations of total AC power may be off by as much as 44%, and estimations of total power may be off by as much as 26%. Accordingly, the systems and methods described herein advantageously provide for more accurate power estimation with IP components, preferably with complex IP components.

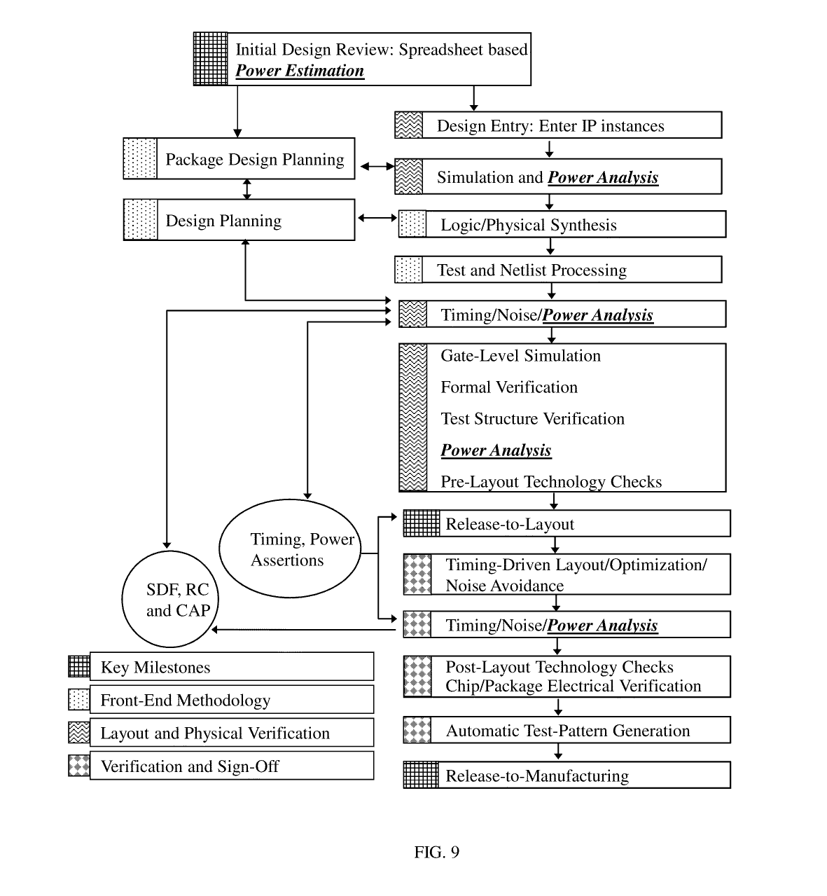

Moreover, the systems and methods described herein advantageously provide power estimations and analysis early and late in design stages. Specifically, FIG. 9 illustrates an exemplary application specific integrated circuit (ASIC) design flow using the methods and systems of the present invention to calculate and or estimate power consumption for an ASIC chip. In accordance with aspects of the present invention, the methods and systems discussed herein provide for the ability to use design activity specifications at every step, and the pin attribute models allow the design activity specifications to be applied in a power analysis tool for each design step. Advantageously, a feedback mechanism is provided allowing for design changes at each step of the design flow, and no simulation or connectivity is needed early on in the design process.

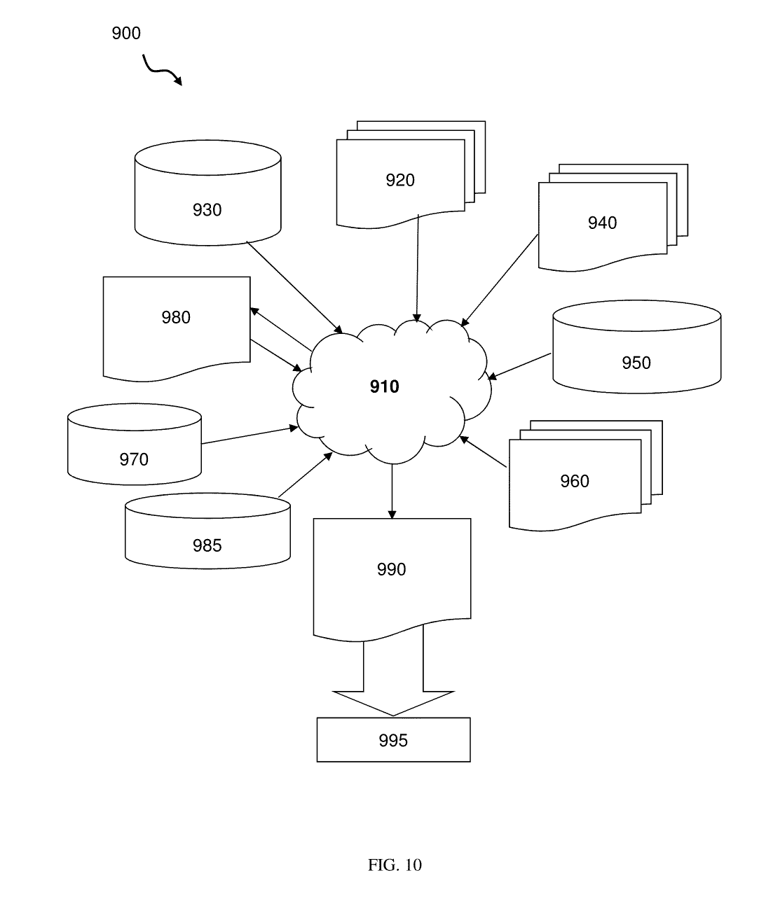

FIG. 10 is a flow diagram of a design process used in semiconductor design, manufacture, and/or test used with the system and method of the present invention. FIG. 10 shows a block diagram of an exemplary design flow 900 used for example, in semiconductor IC logic design, simulation, test, layout, and manufacture. Design flow 900 includes processes, machines and/or mechanisms for processing design structures or devices to generate logically or otherwise functionally equivalent representations of the design structures and/or devices. The design structures processed and/or generated by design flow 900 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 900 may vary depending on the type of representation being designed. For example, a design flow 900 for building an ASIC may differ from a design flow 900 for designing a standard component or from a design flow 900 for instantiating the design into a programmable array, for example a programmable gate array (PGA) or a field programmable gate array (FPGA) offered by Altera® Inc. or Xilinx® Inc.

FIG. 10 illustrates multiple such design structures including an input design structure 920 that is preferably processed by a design process 910. Design structure 920 may be a logical simulation design structure generated and processed by design process 910 to produce a logically equivalent functional representation of a hardware device. Design structure 920 may also or alternatively comprise data and/or program instructions that when processed by design process 910, generate a functional representation of the physical structure of a hardware device. Whether representing functional and/or structural design features, design structure 920 may be generated using electronic computer-aided design (ECAD) such as implemented by a core developer/designer. When encoded on a machine-readable data transmission, gate array, or storage medium, design structure 920 may be accessed and processed by one or more hardware and/or software modules within design process 910 to simulate or otherwise functionally represent an electronic component, circuit, electronic or logic module, apparatus, device, or system, which can be implemented with the method and system of the present invention. As such, design structure 920 may comprise files or other data structures including human and/or machine-readable source code, compiled structures, and computer-executable code structures that when processed by a design or simulation data processing system functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 910 preferably employs and incorporates hardware and/or software modules for synthesizing, translating, or otherwise processing a design/simulation functional equivalent of the components, circuits, devices, or logic structures to generate a netlist 980 which may contain design structures such as design structure 920. Netlist 980 may comprise, for example, compiled or otherwise processed data structures representing a list of wires, discrete components, logic gates, control circuits, I/O devices, models, etc. that describes the connections to other elements and circuits in an integrated circuit design. Netlist 980 may be synthesized using an iterative process in which netlist 980 is resynthesized one or more times depending on design specifications and parameters for the device. As with other design structure types described herein, netlist 980 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 910 may include hardware and software modules for processing a variety of input data structure types including netlist 980. Such data structure types may reside, for example, within library elements 930 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 940, characterization data 950, verification data 960, design rules 970, and test data files 985 that may include input test patterns, output test results, and other testing information. Design process 910 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 910 without deviating from the scope and spirit of the invention. Design process 910 may also include modules for performing standard circuit design processes such as timing analysis, verification, design rule checking, place and route operations, etc.

Design process 910 employs and incorporates logic and physical design tools such as HDL compilers and simulation model build tools to process design structure 920 together with some or all of the depicted supporting data structures along with any additional mechanical design or data (if applicable), to generate a second design structure 990.

Design structure 990 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 920, design structure 990 preferably comprises one or more files, data structures, or other computer-encoded data or instructions that reside on transmission or data storage media and that when processed by an ECAD system generate a logically or otherwise functionally equivalent form of one or more devices. In one embodiment, design structure 990 may comprise a compiled, executable HDL simulation model that functionally simulates the devices.

Design structure 990 may also employ a data format used for the exchange of layout data of integrated circuits and/or symbolic data format (e.g. information stored in a GDSII (GDS2), GL1, OASIS, map files, or any other suitable format for storing such design data structures). Design structure 990 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure. Design structure 990 may then proceed to a stage 995 where, for example, design structure 990: proceeds to tape-out, is released to manufacturing, is released to a mask house, is sent to another design house, is sent back to the customer, etc.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for performing a power analysis of an intellectual property (IP) design, the method comprising:
generating an activity map that reflects power attributes for each pin that impacts power in the IP design;
generating specific activity assertions based on the power attributes and chip level usage information for the IP design; and
using a computing device to perform the power analysis using the specific activity assertions.

2. The method of claim 1, wherein the power attributes comprise at least one of a switching factor attribute and a duty cycle attribute.

3. The method of claim 2, wherein the specific activity assertions comprise at least one of switching factor information and duty cycle information generated from the at least one of the switching factor attribute and the duty cycle attribute.

4. The method of claim 1, wherein the chip level usage information comprises access or usage percentages for the IP component.

5. The method of claim 4, wherein the access or usage percentages comprise read, write, sleep, refresh, and search usage percentages.

6. The method of claim 1, further comprising receiving the power attributes from a power model for the IP design.

7. The method of claim 6, wherein the power attributes define a function for each of the pins.

8. The method of claim 7, wherein the access or usage percentages are provided by a chip level designer.

9. A method for performing a power analysis of an intellectual property (IP) component, the method comprising:
identifying each pin that has power implications for the IP component;
defining at least one parameter for each of the identified pins;
generating a function for each of the identified pins using the defined at least one parameter;
receiving chip level usage information for the IP component;
generating a specific activity assertion for each of the pins using the function generated for each pin respectively and the chip level usage information; and
using a computing device to perform the power analysis using the specific activity assertions.

10. The method of claim 9, wherein the chip level usage information comprises access or usage percentages for the IP component.

11. The method of claim 10, wherein the access or usage percentages comprise read, write, sleep, refresh, and search usage percentages.

12. The method of claim 9, wherein the function for each of the identified pins comprises at least one of an activity factor power attribute and a duty cycle power attribute.

13. The method of claim 12, wherein the least one of the activity factor power attribute and the duty cycle power attribute comprises the at least one parameter.

14. The method of claim 13, wherein the specific activity assertion comprises at least one of activity factor information and duty cycle information generated from the at least one of the activity factor power attribute and the duty cycle power attribute.

15. The method of claim 9, further comprising receiving the function from a power model for the IP component.

16. The method of claim 15, wherein the chip level usage information is provided by a chip level designer.

17. A computing system for performing a power analysis of an intellectual property (IP) design, the computer system comprising:
a CPU, a computer readable memory and a computer readable storage media;
first program instructions to generate an activity map that reflects power attributes for each pin that impacts power in the IP design;
second program instructions to generate specific activity assertions based on the power attributes and chip level usage information for the IP design; and
third program instructions to perform the power analysis using the specific activity assertions,
wherein the first, second and third program instructions are stored on the computer readable storage media for execution by the CPU via the computer readable memory.

18. The computing system of claim 17, wherein the power attributes comprise at least one of a switching factor attribute and a duty cycle attribute.

19. The computing system of claim 18, further comprising fourth program instructions to receive the power attributes from a power model for the IP design.

20. The computing system of claim 19, wherein the chip level usage information is provided by a chip level designer.

21. A method for capturing and combining chip level usage information and intellectual property (IP) information, the method comprising:
identifying each input/output (I/O) pin that has power implications for an IP component;
defining at least one parameter for each of the identified I/O pins;
generating a function for each of the identified I/O pins using the defined at least one parameter, wherein the function is configured to generate a specific activity assertion for each of the I/O pins respectively;
receiving the chip level usage information for the IP component; and
generating the specific activity assertion for each of the I/O pins using a computing device, wherein the specific activity assertion is generated based on the function generated for each of the identified I/O pins and the received chip level usage information.

22. The method of claim 21, wherein the chip level usage information comprises access or usage percentages for the IP component.

23. The method of claim 21, wherein:
the function comprises at least one of an activity factor power attribute and a duty cycle power attribute;
the least one of the activity factor power attribute and the duty cycle power attribute comprises the at least one parameter; and
the specific activity assertion comprises at least one of activity factor information and duty cycle information generated from the at least one of the activity factor power attribute and the duty cycle power attribute.

24. The method of claim 21, further comprising receiving the function for each of the identified I/O pins from a power model for the IP component, wherein the power model comprises power attributes for each of the identified I/O pins, and the power attributes define the function for each of the identified I/O pins.

25. The method of claim 24, wherein the chip level usage information is provided by a chip level designer.
